(19) United States
(12) Patent Application Publication
(10) Pub. No.: US 2004/0249705 A1
(43) Pub. Date: Dec. 9, 2004

(54) Systems and methods for facilitating real estate transactions

(75) Inventors: Robert B. Spencer, Denver, CO (US); Richard W. Dubois JR., Littleton, CO (US); Robert O. Campbell, Lakewood, CO (US)

Correspondence Address: FAEGRE & BENSON LLP, PATENT DOCKETING, 2200 WELLS FARGO CENTER, 90 SOUTH 7TH STREET, MINNEAPOLIS, MN, 55402-3901, US

(73) Assignee: Perpetual Innovations Company LLC, Lakewood, CO

(21) Appl. No.: 10/455,099

(22) Filed: Jun. 4, 2003

(51) Int. Cl. G06F 17/60

(52) U.S. Cl. 705/14; 705/1

(57) ABSTRACT

Systems and methods for facilitating real estate transactions. Various of the systems and methods provide for incorporating information about associated real estate professionals on a common interface. This association facilitates seamless processing between a potential purchaser and real estate professionals associated with various aspects of a real estate transaction. Thus, for example, a purchaser can be quickly directed from a real estate agent to a mortgage broker, or to other real estate professionals providing one or more services in relation to a property transaction.

### BACKGROUND OF THE INVENTION

The present invention provides systems and methods useful in relation to identifying and purchasing property. More particularly, the present invention provides systems and methods for facilitating real estate transactions.

In a typical real estate transaction, a real estate agent may refer a purchaser to a mortgage agent to procure a mortgage. In turn, the mortgage agent may pay a referral fee to real estate agent. This referral fee has often been passed on to the purchaser in a form that was not disclosed as a referral fee. To combat this practice, congress passed the Real Estate Settlement Procedures Act to provide the consumer protection from “. . . unnecessarily high settlement charges caused by certain abusive practices that have developed in some areas of the country” including referral fees, or kickbacks. See Buying Your Home, U.S. Department of Housing and Urban Development Office of Housing-Federal Housing Commission, June 1997, p. 9.

While this law has limited the abusive practices, it has also limited the ability for various real estate professionals to work together to provide a satisfactory real estate experience. Among other things, the present invention provides systems and methods to facilitate a satisfactory transaction process.

### BRIEF SUMMARY OF THE INVENTION

The present invention provides various systems and methods for facilitating real estate transactions. In one particular embodiment of the present invention, a series of communication elements are assembled such that a potential purchaser is given access to a wealth of information related to a particular property. Such an embodiment avoids the problems where advertising materials are not available, and there is no mechanism for asking a seller additional questions. In the embodiment, an advertising sign located near the property, or the property itself, includes a transmitter that transmits a code associated with the property. A potential purchaser passes the sign and acquires the transmitted code. In turn, the transmitted code is used to access an Internet webpage over a Wi-Fi network. The webpage includes information about the property, the real estate agent representing the property, a mortgage agent that can be contacted in relation to the property, and the like. A contact is provided for the real estate agent, where an appointment can be made with the real estate agent to access the property. In addition, a contact is provided for the mortgage agent, and the mortgage agent can be contacted in real time to obtain loan information and monthly payment information. All of this information can be stored in the purchaser's access device for printing and/or further analysis at a later date. Thus, using such a system, a potential purchaser can be given a myriad of information about a property, and an ability to schedule access to the property, all while sitting on the street in front of the property.

Some embodiments of the present invention do not necessarily include the series of communication elements as described in relation to the aforementioned embodiment. One example of these embodiments comprises a computer readable medium including information about various real estate professionals. In addition, the computer readable medium includes information about relationships between the various real estate professionals and software executable to match one or more of the real estate professionals with other of the real estate professionals.

As one example of the operation of such a system, two groups of real estate professionals may be included on the computer readable medium—one group of real estate professionals may be mortgage agents, and the other group may be real estate agents. One of the mortgage agents may provide a code to a potential purchaser. This code is entered by the potential purchaser via an Internet webpage and is used to identify the mortgage agent that provided the code. In addition, one or more real estate agents associated with the mortgage agent can be identified using the relationship information, and the software can gather information about both the mortgage agent and the associated real estate agent(s). This information can be presented on a common advertisement, and access to both professionals can be coordinated via the systems and methods of the present invention. Such an approach can provide a seamless real estate transaction process from a purchaser's perspective. Further, the service can be paid for by the mortgage agent as a way of generating additional business by aiding potential purchasers through the various processes associated with purchasing real estate. Further, RESPA compliance can be aided by providing a compliant resource through which real estate professionals can operate.

Various embodiments of the present invention provide methods whereby a real estate professional provides a code to a potential purchaser, along with a uniform record locator. In some cases, the code is imbedded with a uniform record locator, thus obviating the need to provide both a code and a uniform record locator. In particular cases, the code is specific to the real estate professional, but does not offer any additional information about the property or the purchaser. In other cases, the code is specific to the property, while in yet other cases, the code is specific to both the property and the purchaser.

A potential purchaser accesses an Internet webpage, or other network site and provides the code and/or uniform record locator. In some cases, the code is authenticated and/or authorized prior to allowing access to the site. Based on the received code and/or uniform record locator, the potential purchaser is provided with an interface that is tailored to facilitate the purchase process, or marketing processes associated with a real estate transaction. This interface can include information about the real estate agent, and one or more mortgage agents that are in some way associated with the real estate agent. In some cases, the real estate agents provide a list of mortgage agents that they feel provide high quality mortgage services at a competitive price. Thus, some aspects of the invention provide a mechanism that allows real estate professionals that consistently work with other professionals to rate such professionals and include or exclude those professionals from a referral list in a way that does not involve illegal kick backs. Alternatively, or in addition, the mortgage agents can associate real estate agents, and provide a similar service of rating the real estate agents.

Where the code is provided by a real estate agent, the provided interface may list one or more mortgage agents suggested by the real estate agent. The potential purchaser can then select one of the mortgage agents, and from there can be presented with an interface specific to that mortgage agent. The provided interface can include information about both the real estate agent and the mortgage agent.

In one case where the code is specific to the real estate agent providing the code, but does not provide information about a property or the purchaser, the potential purchaser is queried by the interface to provide information about the purchaser including home address, telephone number, income information, credit information, employment information, authorizations to verify credit and employment information, and/or the like. In addition, the potential purchaser can also be queried for information about the property to be purchased including the cost of the property, a proposed down payment, home owners association dues, property insurance, the multiple listing service number, the property address, and/or the like.

In another case where the code includes property information, the potential purchaser may only be queried to provide information about the purchaser as previously discussed. In some cases, the real estate agent has provided the information about the property to a central source that in turn issued the code. In yet another case where the code includes property information and purchaser information, the interface may only query for purchaser information that is sensitive, and thus may not have been shared with the real estate agent. For example, the interface may only query only for sensitive information such as income and credit information.

In addition the interface may query for the type of loan desired. Such loan types can include, but are not limited to, FHA, VHA, convention, and ARM type mortgage loans. Further, a desired loan term, such as ten years, fifteen years, or thirty years may be selected. Based on this information, an interface specific to the selected mortgage agent can be provided that includes a quoted interest rate for the selected mortgage type, as well as an estimate for the closing costs and an estimated monthly payment. The interface can further be interactive so that the potential purchaser can modify one or more of the parameters to get the monthly payment and/or closing costs to an acceptable level. For example, the purchaser can adjust the down payment, or total cost of the property to obtain the desired monthly payment.

In other cases, two or more loan types may be presented simultaneously to allow a potential purchaser to do a side by side comparison of the various loan types. Once the particular loan type is selected, and the parameters associated with that loan type are finalized, another interface can be provided that includes information related to a closing cost estimate for mortgage services. In some cases, this closing cost estimate can be executed using electronic signature technology by one or both of the potential purchaser and/or the mortgage agent. This estimate can include information about both the real estate agent and the mortgage agent.

In some cases, a full set of documentation can be provided electronically to the potential purchaser. This can include, information about the property including the location, size, layout, and/or a photograph of the property. In addition, this can include photographs of both the real estate agent and the mortgage agent, along with contact information for both of them. Yet further, the documentation can include the monthly payment information, and the information about the selected loan and closing cost estimate. In addition, a pre-qualification certificate can also be provided in relation to the previous documentation.

Other embodiments of the present invention provide a method whereby a mortgage agent provides a code to a potential purchaser. The purchaser enters the code via a communication network, and is provided with an interface where the potential purchaser can enter various loan and property information. In turn, the mortgage agent can provide estimated loan information and/or a closing cost estimate confirmed via electronic signatures. Yet further, the potential purchaser can be pre-qualified, and the pre-qualification information provided to the potential purchaser's real estate agent.

In various embodiments, joint advertising between various real estate professionals can be provided. Thus, for example, beyond the real estate agent and mortgage agent, a referral list of other real estate professionals can be provided in relation to one or more of a real estate agent and/or mortgage agent. Such other real estate professionals may include appraisers, contractors, attorneys, cleaners, decorators, and the like. Thus, again, those who consistently work with such professionals can be placed in a position to rate various professionals, and to direct purchasers that may not have experience with such professionals.

Yet other aspects of the present invention include receiving a mortgage quote from a potential purchaser. An “apples to apples” comparison can then be provided to the purchaser via a communication network. Further, in some cases, the mortgage agent associated with the system can be provided an opportunity to match the provided quote, and thereby gain an advantage in selling mortgage services. This price matching function can be provided automatically where the adjustment fits within a predefined range. Alternatively, or in addition, a real time communication can be established with the mortgage agent allowing the parties to negotiate. In some cases, a lock-out feature is included whereby a potential purchaser can be precluded from entering multiple “low-ball” quotes. Thus, for example, where a quote is determined to be too low, the potential purchaser can be precluded from additional access to the negotiation system.

Some embodiments of the present invention include systems for facilitating real estate transactions. Such systems include a transmitter associated with a property for sale. This transmitter can, for example, be incorporated into a for sale sign posted on the property. The transmitter transmits a code that directs access to a webpage available via, for example, the Internet. A network device operated by a potential purchaser of the property can receive the transmitted code, and access a webpage based on the transmitted code via a communication network. An interface with information about the property for sale can be provided to the network device. The interface can provide information about a real estate agent, a mortgage agent, and the property. The network device can request another interface, wherein this other interface is tailored to receive loan information. The loan information can be provided to a central system, and yet another interface can be received that includes an estimated monthly cost for the property. Some of the property information, real estate agent information, mortgage agent information, and/or monthly payment information can be saved to a computer readable medium incorporated in the network access device.

Other embodiments of the present invention provide systems for matching real estate professionals. The systems include a microprocessor based match engine that is communicably coupled to a first computer readable medium, a second computer readable medium, a third computer readable medium, and a fourth computer readable medium. The first computer readable medium comprises a group of real estate professionals of a first type, and the second computer readable medium comprises a group of real estate professionals of a second type. The third computer readable medium comprises a relationship between one or more of the group of real estate professionals of the first type and at least one of the real estate professionals of the second type. The fourth computer readable medium comprises instructions executable by the match engine to: receive a code via a computer network, wherein the code is associated with a first real estate professional from the group of real estate professionals of the first type; access the first computer readable medium, and obtain a first data set associated with the first real estate professional; access the third computer readable medium to obtain relationship information; matching the first real estate professional with a second real estate professional from the group of real estate professionals of the second type; access a second data set associated with the second real estate professional; and provide an interface via the computer network where the interface displays the first real estate professional and the second real estate professional.

Yet other embodiments of the present invention provide methods for facilitating a real estate transaction. The methods include associating a code with a real estate entity, and receiving the code via a communication network. Based at least in part on the code, a first data set associated with the real estate entity is accessed, and the real estate entity is matched to an associated entity. A second data set associated with the associated entity is accessed, and an interface is provided via the communication network that includes the first and second data sets. In some instances, the real estate entity is a real estate agent, while in other instances, the real estate entity is a mortgage agent. The associated entity can be, among other things, a real estate agent or a mortgage agent.

In some instances, the methods further include providing another interface that is tailored to accept information selected from a group consisting of: personal identification information, income information, credit information, employment information, authorizations to verify credit and employment information, location of a property to be purchased, cost of a property to be purchased, proposed down payment, home owners association dues, property insurance, and a multiple listing service number. In addition, yet another interface can be provided that includes an estimate of closing costs specific to one or both of the real estate entity and the associated entity.

In other instances, another interface can be provided that is tailored to accept information selected from a group consisting of: personal identification information, location of a property to be sold, cost of a property to be sold, and outstanding liabilities on the property to be sold. In addition, yet another interface is provided that includes a seller's net interface using information specific to one or both of the real estate entity and the associated entity.

Yet other embodiments include methods for providing a seamless real estate transaction. The methods include providing a code associated with a proposed transaction, and that indicates a real estate agent. The code is received, and an informational interface is provided that includes information about the real estate agent, and one or more mortgage agents associated with the real estate agent. Transaction information is requested and received. Based at least in part on this transaction information, an estimate of the transaction costs is provided on an interface that includes contact information for both the real estate agent and a selected mortgage agent.

This summary provides only a general outline of some embodiments according to the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the nature and advantages of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 depicts a system in accordance with embodiments of the present invention for facilitating real estate transactions;

FIG. 2 depicts another system in accordance with embodiments of the present invention for facilitating real estate transactions;

FIG. 3 is a flow diagram illustrating a method in accordance with the present invention;

FIG. 4 depicts an agent specific access interface in accordance with some embodiments of the present invention;

FIG. 5 is an agent specific seller net input interface useful in relation to various embodiments of the present invention;

FIG. 6 is an agent specific seller net projection in accordance with various embodiments of the present invention;

FIG. 7 is an agent specific closing estimator interface useful in relation to various embodiments of the present invention;

FIG. 8 is an agent specific closing projection in accordance with various embodiments of the present invention;

FIG. 9 is an agent specific property information sheet in accordance with some embodiments of the present invention; and

FIGS. 10 and 11 illustrate various joint marketing materials that can be produced using systems and methods in accordance with the present invention.

### DETAILED DESCRIPTION OF THE INVENTION

The present invention provides various systems and methods for facilitating real estate transactions. In one particular embodiment of the present invention, a series of communication elements are assembled such that a potential purchaser is given access to a wealth of information related to a particular property. Such an embodiment avoids the problems where advertising materials are not available, and there is no mechanism for asking a seller additional questions. In the embodiment, an advertising sign located near the property, or the property itself, includes a transmitter that transmits a code associated with the property. A potential purchaser passes the sign and acquires the transmitted code. In turn, the transmitted code is used to access an Internet webpage over a Wi-Fi network.

The webpage includes information about the property, the real estate agent representing the property, a mortgage agent that can be contacted in relation to the property, and the like. A contact is provided for the real estate agent, where an appointment can be made with the real estate agent to access the property. In addition, a contact is provided for the mortgage agent, and the mortgage agent can be contacted in real time to obtain loan information and monthly payment information. All of this information can be stored in the purchaser's access device for printing and/or further analysis at a later date. Thus, using such a system, a potential purchaser can be given a myriad of information about a property, and an ability to schedule access to the property, all while sitting on the street in front of the property.

Other embodiments of the present invention do not necessarily include the transmission of information local to the property to be purchased, but rather provides for accessing information about real estate professionals and/or properties from a computer communicably coupled to the Internet. One example of these other embodiments comprises a computer readable medium including information about various real estate professionals. In addition, the computer readable medium includes information about relationships between the various real estate professionals and software executable to match one or more of the real estate professionals with other of the real estate professionals.

As one example of the operation of such a system, two groups of real estate professionals may be included on the computer readable medium—one group of real estate professionals may be mortgage agents, and the other group may be real estate agents. One of the mortgage agents may provide a code to a potential purchaser. This code is entered by the potential purchaser via an Internet webpage and is used to identify the mortgage agent that provided the code. In addition, one or more real estate agents associated with the mortgage agent can be identified using the relationship information, and the software can gather information about both the mortgage agent and the associated real estate agent(s). This information can be presented on a common advertisement, and access to both professionals can be coordinated via the systems and methods of the present invention. Such an approach can provide a seamless real estate transaction process from a purchaser's perspective. Further, the service can be paid for by the mortgage agent as a way of generating additional business by aiding potential purchasers through the various processes associated with purchasing real estate. Further, RESPA compliance can be aided by providing a compliant resource through which real estate professionals can operate.

Various embodiments of the present invention provide methods where a real estate agent provides a code to a potential purchaser, along with a uniform record locator. In some cases, the code is imbedded with a uniform record locator, thus obviating the need to provide both a code and a uniform record locator. In particular cases, the code is specific to the real estate agent, but does not offer any additional information about the property or the purchaser. In other cases, the code is specific to the property, while in yet other cases, the code is specific to both the property and the purchaser.

A potential purchaser accesses an Internet webpage, or other network site and provides the code and/or uniform record locator. In some cases, the code is authenticated and/or authorized prior to allowing access to the site. Based on the received code and/or uniform record locator, the potential purchaser is provided with an interface that is tailored to facilitate the purchase process, or marketing processes associated with a real estate transaction. This interface can include information about the real estate agent, and one or more mortgage agents that are in some way associated with the real estate agent. In some cases, the real estate agents provide a list of mortgage agents that they feel provide high quality mortgage services at a competitive price. Thus, some aspects of the invention provide a mechanism that allows real estate professionals that consistently work with other professionals to rate such professionals and include or exclude those professionals from a referral list in a way that does not involve illegal kick backs. Further, the present invention provides a mechanism for adding information about the referrals by simply indicating the professional to be referred. Alternatively, or in addition, the mortgage agents can associate real estate agents with them, and provide a similar service of rating the real estate agents.

Where the code is provided by a real estate agent, the interface provided in relation to the code may list one or more mortgage agents that they suggest. The potential purchaser can then select one of the mortgage agents, and from there can be presented with an interface specific to that mortgage agent. The provided interface can include information about both the real estate agent and the mortgage agent.

In one case where the code is specific to the real estate agent providing the code, but does not provide information about a property or the purchaser, the potential purchaser is queried by the interface to provide information about the purchaser including home address, telephone number, income information, credit information, employment information, authorizations to verify credit and employment information, and/or the like. In addition, the potential purchaser can also be queried for information about the property to be purchased including the cost of the property, a proposed down payment, home owners association dues, property insurance, the multiple listing service number, the property address, and/or the like.

In another case where the code includes property information, the potential purchaser may only be queried to provide information about the purchaser as previously discussed. In some cases, the real estate agent has provided the information about the property to a central source that in turn issued the code. In yet another case where the code includes property information and purchaser information, the interface may only query for purchaser information that is sensitive and may not have been shared with the real estate agent. For example, the interface may only query for income and credit information.

In addition the interface may query for the type of loan desired. Such loan types can include, but are not limited to, FHA, VHA, convention, and ARM type mortgage loans. Further, a desired loan term, such as ten years, fifteen years, or thirty years may be selected. Based on this information, an interface specific to the selected mortgage agent can be provided that includes a quoted interest rate for the selected mortgage type, as well as an estimate for the closing costs and an estimated monthly payment. The interface can further be interactive so that the potential purchaser can modify one or more of the parameters to get the monthly payment and/or closing costs to an acceptable level. For example, the purchaser can adjust the down payment, or total cost of the property to obtain the desired monthly payment.

In other cases, two or more loan types may be presented simultaneously to allow a potential purchaser to do a side by side comparison of the various loan types. Once the particular loan type is selected, and the parameters associated with that loan type are finalized, another interface can be provided that includes information related to a closing cost estimate for mortgage services. In some cases, this closing cost estimate can be executed using electronic signature technology by one or both of the potential purchaser and/or the mortgage agent. This estimate can include information about both the real estate agent and the mortgage agent.

In some cases, a full set of documentation can be provided electronically to the potential purchaser. This can include, information about the property including the location, size, layout, and/or a photograph of the property. In addition, this can include photographs of both the real estate agent and the mortgage agent, along with contact information for both of them. Yet further, the documentation can include the monthly payment information, and the information about the selected loan and closing cost estimate. In addition, a pre-qualification certificate can also be provided in relation to the previous documentation.

Other embodiments of the present invention provide a method where a mortgage agent provides a code to a potential purchaser. The purchaser enters the code via a communication network, and is provided with an interface where the potential purchaser can enter various loan and property information. In turn, the mortgage agent can provide estimated loan information and/or a closing cost estimate confirmed via electronic signatures. Yet further, the potential purchaser can be pre-qualified, and the pre-qualification information provided to the potential purchaser's real estate agent.

In various embodiments, joint advertising between various real estate professionals can be provided. Thus, for example, beyond the real estate agent and mortgage agent, a referral list of other real estate professionals can be provided in relation to one or more of a real estate agent and/or mortgage agent. Such real estate professionals may include appraisers, contractors, attorneys, cleaners, decorators, and the like. Thus, again, those who consistently work with such professionals can be placed in a position to rate various professionals, and to direct purchasers that may not have experience with such professionals.

The various methods of the present invention can also incorporate electronic income verification, credit verification, and automated underwriting, and employment verification. Based on the disclosure provided herein, one of ordinary skill in the art will appreciate the myriad of advantages had through embodiments of the present invention. In addition, one of ordinary skill in the art will appreciate a number of modifications and additional interfaces that can be utilized in relation to the present invention.

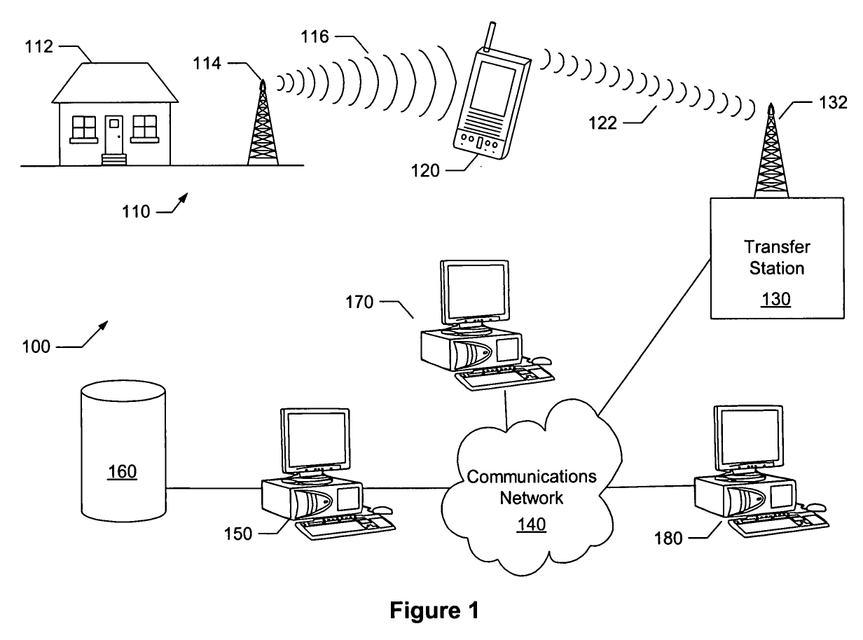

Turning to FIG. 1, a system 100 includes a portable access device 120 capable of receiving an information signal 116 transmitted from a property 110 that includes a real estate item 112 and a transmitter 114. Portable access device 120 is in communication with a transfer station 130 including a receiver/transmitter 132 via a communication link 122. Portable access device 120 can be any microprocessor based device capable of receiving transmitted information over a wireless link, and for transmitting information over a wireless link. Thus, for example, portable access device can be a personal digital assistant (PDA), a notebook computer, an Internet accessible cellular telephone, or the like. In one particular embodiment, the portable access device includes INTEL™ Centrino™ technology for performing the various wireless reception and transmission functions. Such technology can include Wi-Fi technology enabling access to remote databases and/or the Internet in a wireless manner. As used herein, a Wi-Fi network can be any network accessible by a wireless client device, or via a wireless access point that complies with the wireless standards developed in association with IEEE 802.11, including, for example, IEEE 802.11(a), IEEE 802.11(b), an IEEE 802.11(g). Thus, for example, a Wi-Fi device can be a compliant modem, a PDA, a cellular telephone, a laptop computer, a pager, a commercially available access point, and the like.

In one particular embodiment, transmitter 114 and receiver/transmitter 132 are the same device, and transfer station 130 is implemented as a W-Fi access port in or near property 110. In other embodiments, transmitter 114 is a transmitter associated with a real estate advertising sign mounted on the property 110, while transfer station 130 is a Wi-Fi access port accessible from a location near property 110. The network of communication devices as illustrated can provide property information, and/or a code to a potential purchaser. The potential purchaser can then use the property information and/or code to access one or more Internet WebPages to secure additional property information. In various cases, none of transmitter 114, receiver/transmitter 132, transfer station 130, nor portable access deice 120 are used. Rather, the property information and/or code are obtained from a real estate professional, or read from a real estate advertisement associated with property 110. This property information and/or code can be used similarly to access one or more Internet web pages to secure additional property information.

Either via portable access device 120, or another fixed location access device (not shown), a potential purchaser can provide the aforementioned property information and/or code to access a computer server 150 via a communication network 140. Communication network 140 can be any communication network capable of providing communications between the various elements of system 100. In some embodiments, communication network 140 is the Internet providing message based communication, while in other embodiments, communication network 140 comprises a TCP/IP compliant virtual private network (VPN). In yet other embodiments, communication network 140 includes the Internet for communication between potential purchasers and computer 150, and a VPN between computer 150 and access ports 170, 180. However, it should be recognized that other communication networks could be used to provide similar functionality. For example, communication network 140 can be a local area network (LAN), a wide area network (WAN), a telephone network, a cellular telephone network, a virtual private network (VPN), the Internet, an optical network, a wireless network, or any other similar communication network or combination thereof. Computer server 150 is associated with a database 160 that includes information matching one or more real estate professionals associated with property 110. These matched real estate professionals can also access computer server 150 via access ports 170, 180 communicably coupled to communication network 140.

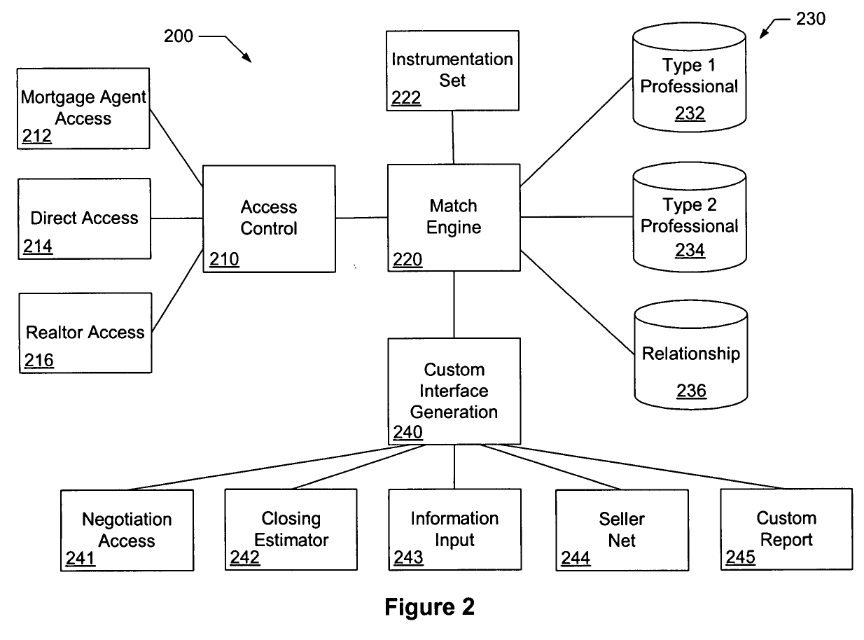

As will be appreciated from discussion of FIG. 2 below, embodiments of the present invention do not necessarily include the portable access device 120, but rather information about various real estate professionals and/or properties can be obtained via the Internet from any location communicably coupled to the Internet. Turning now to FIG. 2, a system 200 for facilitating real estate transactions in accordance with embodiments of the present invention is illustrated. In some embodiments, system 200 is implemented in software running on computer server 150. System 200 includes an access control engine 210 that provides three or more different access points: mortgage agent access 212, direct access 214, and realtor access 216. Other access points can be provided for appraisers, insurance agents, and/or other real estate professionals. Upon accessing system 200, a potential purchaser provides property information and/or a code. The code can be, for example, provided by a real estate agent or via a transmitter 114 programmed by or provided by the real estate agent. Thus, when the potential purchaser provides the code to system 200, realtor access 216 is provided. This can include providing a welcome page with the photograph and contact information about the realtor that provided the code. Alternatively, the potential purchaser may receive property information and/or a code from a mortgage agent. Thus, when the potential purchaser provides the code to system 200, mortgage agent access 212 is provided. This can include providing a welcome page with the photograph and contact information about the mortgage agent that provided the code. As yet another example, the potential purchaser may obtain property information and/or the code via an Internet webpage providing property information. The potential purchaser can then provide this property information and/or code to system 200, in which case the potential purchaser is provided with direct access 214 that may or may not list any real estate professionals.

Upon accessing system 200, a match engine 220 is accessed. Match engine 220 is associated with an instruction set 222 that controls operation of match engine 220. In addition, match engine 220 is associated with a database 230 that includes a database of type I professionals 232, a database of type II professionals 234, and a database of relationship information 236. In some embodiments, each of databases 232, 234, 236 are implemented on separate physical hardware, while in other embodiments, two or more of databases 232, 234, 236 are implemented on common hardware. In one particular embodiment, the databases 232, 234, 236 are maintained on the same hard disk drive, thus, while they may be discussed as three different computer readable mediums, each of the three computer readable mediums comprise a portion of the hard disk drive.

Further, in some embodiments, the information included in databases 232, 234, 236 is interleaved into a common database. Thus, for example, a real estate agent can be included in a record with a mortgage agent and the relationship between the real estate agent and the mortgage agent is implicit in the combination of the two in a common record. In one particular embodiment, type I professionals are real estate agents, and type II professionals are mortgage agents.

In operation, match engine 220 executes instruction set 222 to receive information provided by a potential purchaser, and to match two or more real estate professionals that can aid the potential purchaser. For example, in the case where the code provided by the potential purchaser is a real estate agent code, match engine 220 accesses type I professionals database 232 to obtain information about the real estate agent indicated by the code. Further, match engine 220 accesses relationship database 236 to determine an association between one or more real estate professionals and the identified real estate agent. This information may indicate, for example, a mortgage agent that is associated with the real estate agent. Match engine 220 then accesses type II professionals database 234 to obtain information about the associated mortgage agent. The reverse can also be done. For example, where the code provided by the potential purchaser indicates a mortgage agent, the type II database 234 can be accessed to obtain information about the mortgage agent. Relationship database 236 can be accessed to obtain an associated realtor, and type II database 232 can be accessed to obtain the associated realtor's information.

Match engine 220 then provides the information about the associated real estate professionals to a custom interface generator 240. Custom interface generator 240 is capable of generating one or more interfaces that provide information directed to facilitating a specific real estate transaction. Such information is specific to the associated real estate professionals identified by match engine 220. Such customized interfaces can include, but are not limited to, a negotiation access interface 241, a closing estimator interface 242, an information input interface 243, a seller net interface 244, and a custom report generator interface 245.

Negotiation access interface 241 can include a capability for real time conversation with one or more of the matched real estate professionals. This can be used, for example, to provide a mortgage quote received from a third party mortgage agent and thus to negotiate a change in fees. Thus, a potential purchaser may possibly want to use the mortgage agent associated with the potential purchaser's realtor, but would like to assure that they are receiving the best possible price. The potential purchaser can use negotiation access interface 241 to provide this ability. This can be advantageous to an associated mortgage agent as he/she is provided with the last opportunity to obtain the business of the potential purchaser.

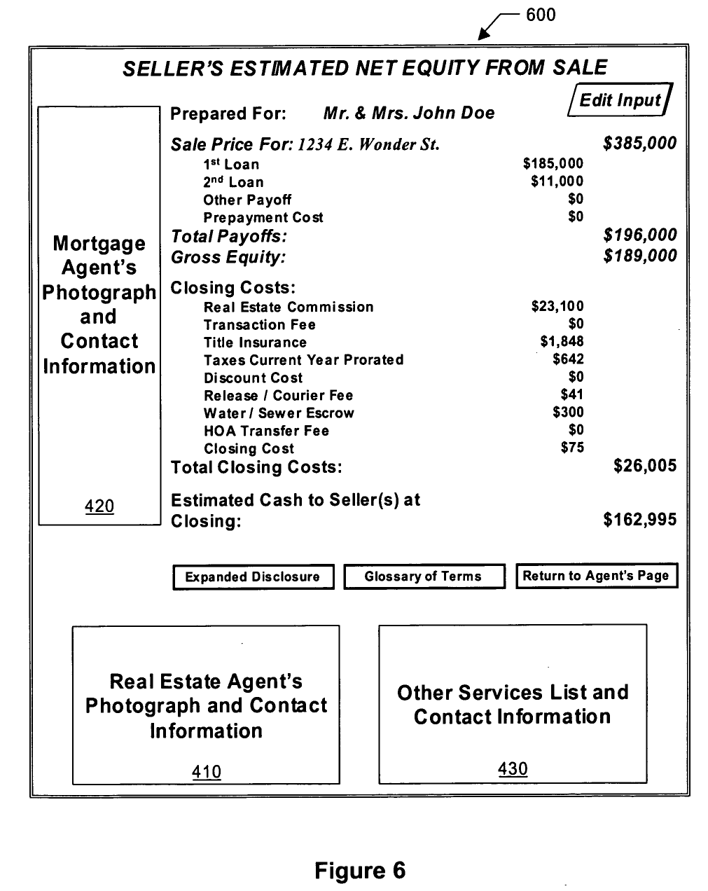

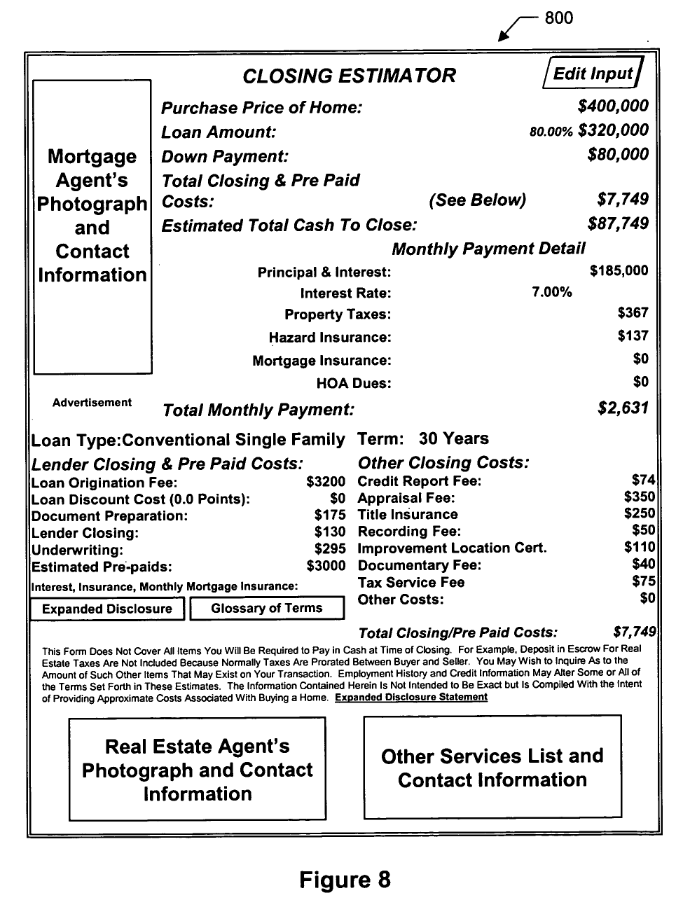

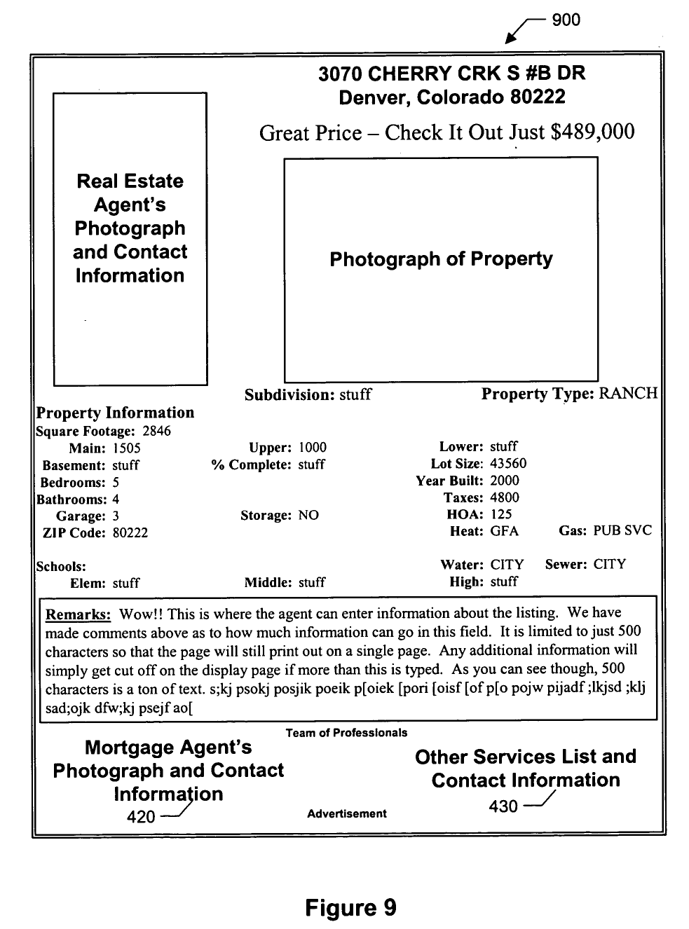

Custom report generator interface 245 allows a user to select one or more reports that can be provided in relation to a particular property. For example, a user may select a property report that includes information about the size, location and design of a property. An example of such a report is discussed in relation to FIG. 9 below. Alternatively, or in addition, a user can select an estimated closing cost report as further discussed below in relation to FIG. 8, and/or a seller's net report as further described below in relation to FIG. 6. Based on the disclosure provided herein, one of ordinary skill in the art will appreciate a number of other reports that can be selected and/or generated. The selected reports can then be communicated electronically, or otherwise to the user.

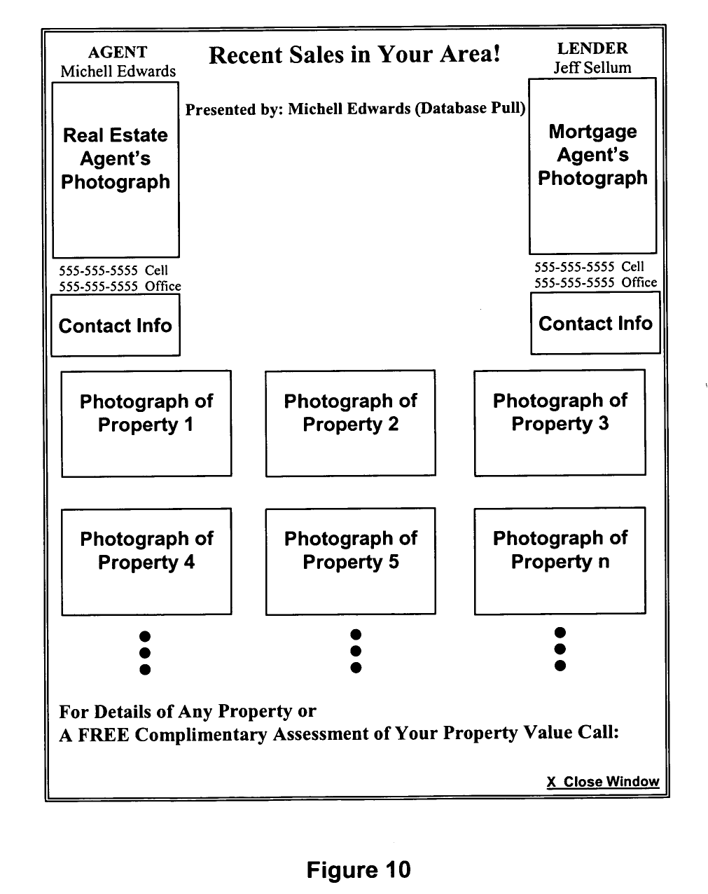

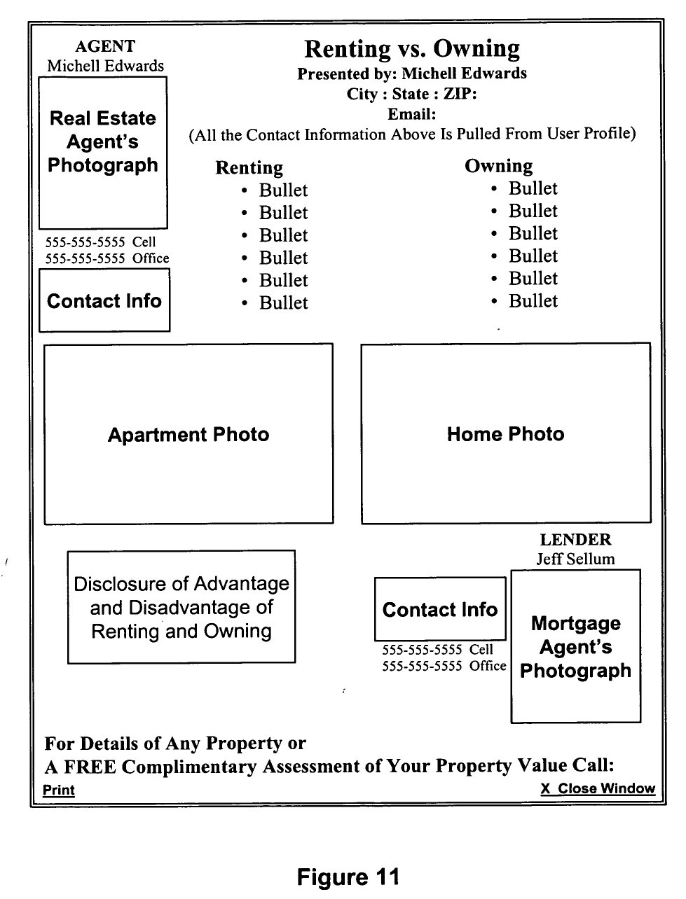

As another example, either or both of the real estate agent or the mortgage agent can access the system to create joint marketing materials that includes contact information for both of the real estate professionals. FIGS. 10 and 11 illustrate two such examples of joint marketing materials. In particular, FIG. 10 depicts a “Recent Sales In Your Area Brochure” that includes both a real estate agent and a mortgage agent. FIG. 11 depicts an informational advertisement helping a potential buyer to understand the relative advantages and disadvantages of owning and selling. Based on the disclosure provided herein, one of ordinary skill in the art will appreciate a number of different types of advertising materials that can be produced using the systems and methods of the present invention.

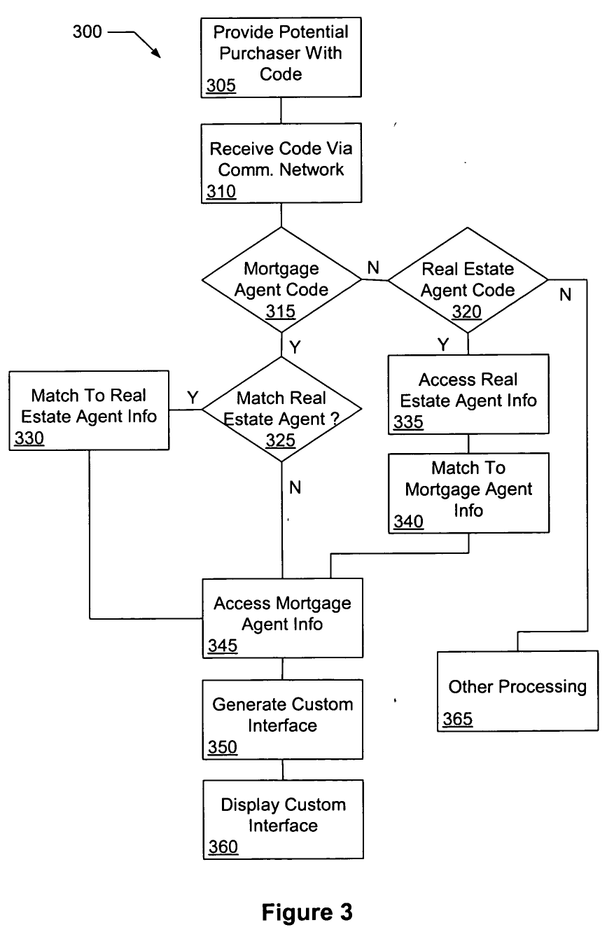

Each of closing estimator interface 242, information input interface 243, and seller net interface 244, are discussed in relation to FIG. 3. Referring to FIG. 3, a flow diagram 300 illustrates the operation of system 200. Following flow diagram 300, a potential purchaser is provided with a code (block 305). As previously suggested, this code can be provided to a potential purchaser in one of various ways. For example, a real estate agent representing the potential purchaser may provide the code to the potential purchaser. In this case, the code can be used by match engine 220 to access information about the real estate agent. Alternatively, the code can be provided to the potential purchaser by the real estate agent representing the seller of the property. This can occur where, for example, the code is obtained using a portable access device as described in relation to FIG. 1 above, or where the code is read from a real estate advertisement associated with the property. In this case, the code can be used by match engine 220 to access information about the real estate agent associated with the seller. As yet another alternative, the code may be provided to the potential purchaser by a mortgage agent. In this case, the code can be used by match engine 220 to access information about the mortgage agent. As yet a further alternative, the code can be provided to the seller from the seller's realtor. Based on the disclosure provided herein, one of ordinary skill in the art will appreciate a myriad of methods to provide the code to a potential purchaser and/or seller.

The code can be produced in one of a variety of ways. For example, a real estate agent can contact an entity maintaining system 200 and request a code. Upon receiving the request, the code can be provided to the real estate agent who can then distribute the code to a potential purchaser or seller. The code can be specific to the real estate agent, to a particular property, and/or to a potential purchaser or seller. The specificity of the code can be controlled by the requesting real estate agent. Thus, for example, the real estate agent may request a relatively generic code that only directs the user to the real estate agent, and other mortgage professionals associated with the real estate agent. Alternatively, the real estate agent may provide greater information about, for example, the property including taxes, home owner's association dues, location, size, and the like. Yet further, information about the purchaser including name, down payment information, and the like can be provided. Thus, the code can designate a real estate agent, one or more associated real estate professionals, a particular property, information about a transaction, and the like. This information is maintained by system 200 in association with the code provided to the real estate agent. Thus, when the code is received, the previously provided information can be retrieved. The same approach and information can be gathered where the code is requested by a mortgage agent, or other real estate professional.

Alternatively, a generic code can be created for each real estate professional associated with system 200. A real estate professional can enroll to use system 200, and a generic code unique to that real estate professional can be provided. The real estate professional can provide this code to a number of potential purchasers and sellers. Each of these purchasers and sellers can then use the real estate professional's code to access the system.

The recipient of a code accesses system 200 by, for example, the Internet. The recipient then provides the received code via an access interface, system 200 receives the code (block 310), and determines whether the code is associated with a realtor, a mortgage agent, or another real estate professional. This determination controls whether mortgage agent access 212, direct access 214, realtor access 216, or another access interface to system 200 is presented. Where it is determined that the code is not associated with a mortgage agent (block 315), or a real estate agent (block 320), other processing is performed (block 365). Such other processing can include providing information related to an insurance agent, a real estate appraiser, or other real estate professional.

Where it is determined that the code is a real estate agent code (block 320), match engine 220 accesses information about the particular real estate agent from database 232 (block 335). This information is used to generate, and provide an interface specific to the real estate agent, referred to as real estate agent access 216. Via this interface, a potential purchaser may select between one or more mortgage agents associated with the real estate agent. The one or more mortgage agents are identified by accessing relationship database 236, and using the identity of the real estate agent to identify an associated mortgage agent (block 340). Where multiple mortgage agents are associated, the potential purchaser may be queried as to which of the mortgage agents they desire to use. Alternatively, selection of a particular mortgage agent may not be necessary where the code originally provided indicates a particular mortgage agent, or where only a single mortgage agent is associated. Information about the particular mortgage agent is accessed from database 234 (block 345).

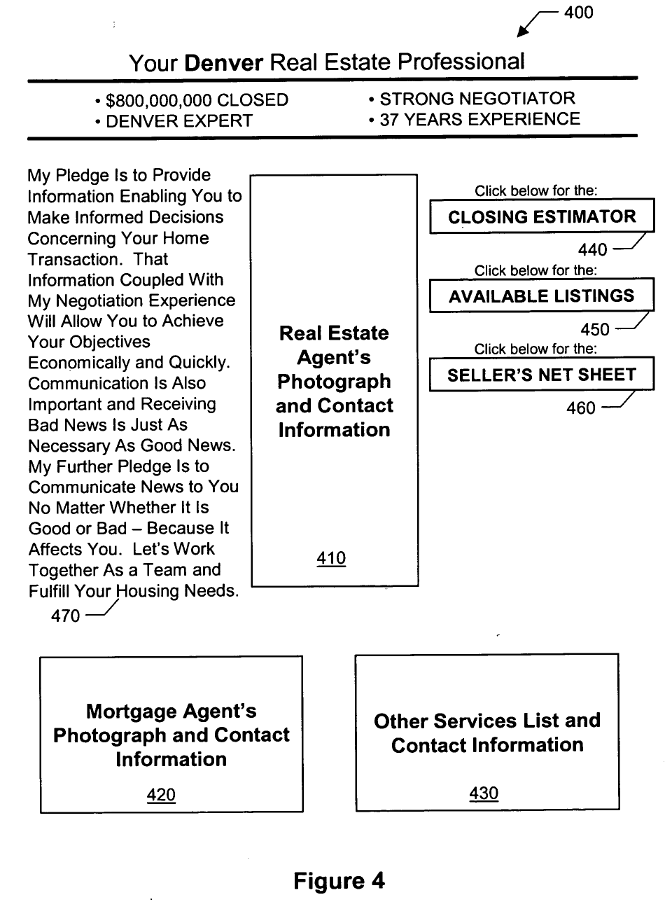

The information about the real estate agent and the mortgage agent is combined to generate a custom, joint interface (block 350), that can be displayed to the potential purchaser (block 360). One example of such a custom, joint interface is provided as FIG. 4. Turning to FIG. 4, an interface 400 includes a photograph and contact information for the real estate agent 410, a photograph and contact information for the associated mortgage agent 420, and a list of other associated professionals and their contact information 430. Interface 400 also includes a link where an accessing potential purchaser, seller, or other user can access a closing estimator 440, available property listings 450, and a seller's net sheet 460. In addition, biographical information 470 about the real estate agent and/or mortgage agent can be provided.

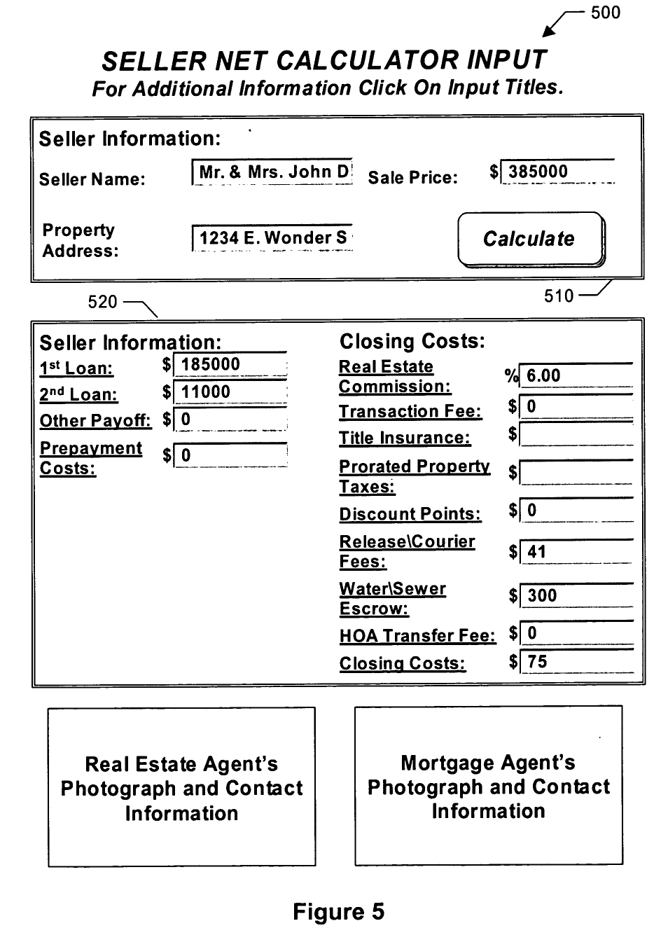

By selecting the seller's net sheet selector 460, an information query interface 500, such as that of FIG. 5 is presented. Interface 500 can include a base information section 510 and an extended information section 520. To obtain a rough seller's net estimate, only the information in section 510 must be provided. Where a more detailed estimate is desired, the information of section 520 can be included.

In some embodiments, one or more of the information blocks in either of section 510 and/or section 520 can be automatically populated with information specific to the particular real estate agent and mortgage agent pair. This information can be garnered from database 232 and/or database 234 where it is maintained in association with the particular real estate agent or mortgage agent. For example, the real estate commission in section 520 can be automatically entered from commission information associated with the real estate agent. In addition, the title insurance fee can be updated using title insurance information available from the mortgage agent. Based on the disclosure provided herein, one of ordinary skill in the art will appreciate that various of the queried information can be automatically updated. Further, the person accessing interface 500 may be allowed to override some of the information to obtain an estimate based on other inputs. Once this information is provided, the user can be presented with a seller's net sheet 600 as depicted in FIG. 6. Seller's net sheet 600 is customized to the characteristics of the real estate agent and mortgage agent, and contact information for both can be presented as part thereof.

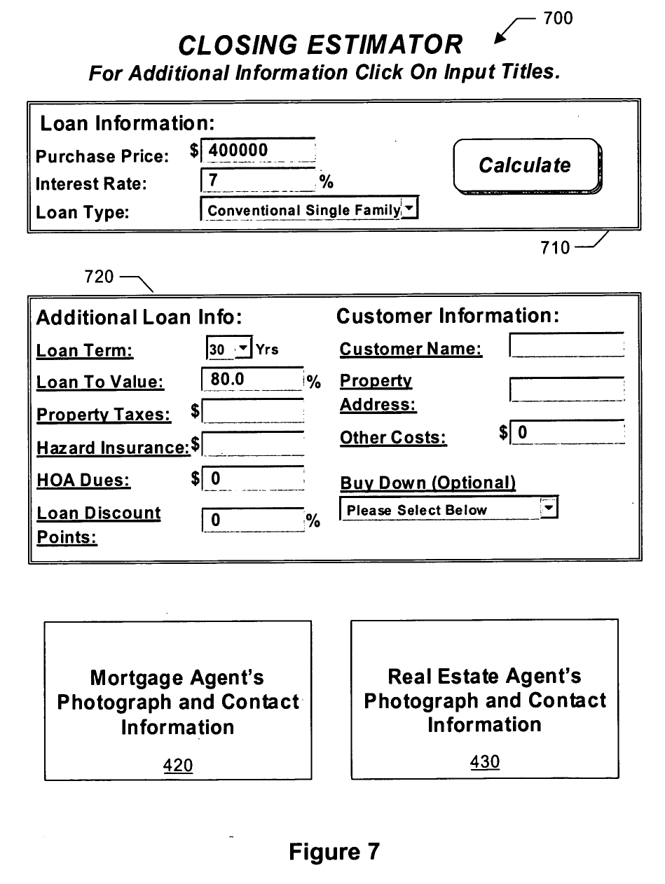

Alternatively, where a user selects closing estimator link 440, a closing estimator interface 700 is presented. Turning to FIG. 7, an example of closing estimator interface 700 is provided. Interface 700 can include a base information section 710 and an extended information section 720. To obtain a rough closing estimation, only the information in section 710 must be provided. Where a more detailed estimate is desired, the information of section 720 can be included.

In some embodiments, one or more of the information blocks in either of section 710 and/or section 720 can be automatically populated with information specific to the particular real estate agent and mortgage agent pair. This information can be garnered from database 232 and/or database 234 where it is maintained in association with the particular real estate agent or mortgage agent. For example, the interest rate offered can be automatically updated from the mortgage agent's information based on the input of the loan type. In addition, the real estate agent's information may include information on the various properties. From this information, the property taxes, and HOA dues can be automatically updated. Based on the disclosure provided herein, one of ordinary skill in the art will appreciate that various of the queried information can be automatically updated. Further, some of the information may be updated by the real estate agent and associated with the code that the real estate agent then provides to the potential purchaser. When the potential purchaser accesses the system using the code, the information is automatically populated into sections 710, 720. Yet further, the person accessing interface 700 may be allowed to override some of the information to obtain an estimate based on other inputs. Once this information is provided, the user can be presented with a closing estimation sheet 800 as depicted in FIG. 8. Closing estimation sheet 800 is customized to the characteristics of the real estate agent and mortgage agent, and contact information for both can be presented thereon.

Additionally, a user can access an interface 900 including property information, and contact information for both the real estate agent and the mortgage agent. Using the system, a user can conveniently obtain the various information useful to making a purchase and/or offer. As just one example, a potential purchaser can be given a code, and use that code to access the system. Based in part on the code, the system can then provide an interface including the real estate agent representing the property and an associated mortgage agent. From this, the seller can access a closing estimator that outputs an estimated monthly payment and down payment associated with the property. All of the information about the property including photographs and descriptions of the property, as well as financial information about the property can be saved on the system, and later accessed by the potential purchaser. This later access can be performed by the potential purchaser from, for example, the home of the potential purchaser. This allows a potential purchaser to visit one or more properties, obtain codes associated with the properties, and then return home and use the system to compare the various properties and financial information associated therewith. Based on the disclosure provided herein, one of ordinary skill in the art will appreciate a number of other ways in which the systems of the present invention can be used.

Returning to FIG. 3, the case where the code indicates a mortgage agent is described in relation to flow diagram 300. Where the code indicates a mortgage agent (block 315), it is determined whether a real estate agent is to be accessed (block 325). In some cases, the mortgage agent is providing a mortgage quote that is unrelated to any real estate agent. In this case, the information about the mortgage agent is accessed from database 234 (block 345), and the various interfaces exclusive to the operation of the mortgage agent are generated and provided (blocks 350, 360). In some cases, these interfaces do not include contact information for a real estate agent, nor access to property information.

Alternatively, where the code indicates an associated real estate agent, (block 325), match engine 220 accesses relationship database 236 to determine the one or more associated real estate agents, and matches the real estate agents to the mortgage agent (block 330). As before, a user may be asked to select one of the real estate agents, or may be asked to specify some criteria, from which an associated real estate agent may be selected. For example, the user may select an area in which they would like to find a property. The system can determine which of the various real estate agents specialize in properties in that area. Once the real estate agent(s) are matched (block 330), information about both the real estate agent(s) and mortgage agent are accessed from databases 232, 234. This information is used to generate custom interfaces (block 350), and to display the interfaces (block 360), similar to that previously described.

The invention has now been described in detail for purposes of clarity and understanding. However, it will be appreciated that certain changes and modifications may be practiced within the scope of the appended claims. Further, the functions of the systems and methods of using such are merely exemplary. Accordingly, it should be recognized that many other systems, functions, methods, and combinations thereof are possible in accordance with the present invention. Thus, although the invention is described with reference to specific embodiments and figures thereof, the embodiments and figures are merely illustrative, and not limiting of the invention. Rather, the scope of the invention is to be determined solely by the appended claims.

What is claimed is:

1. A system for facilitating real estate transactions, the system comprising:
a transmitter associated with a property advertisement, wherein the transmitter transmits a code,
a network access device, wherein the network access device is operable to:
receive the transmitted code;
provide the transmitted code to a source via a communication network;
receive a first interface via the communication network, wherein the first interface includes a real estate agent, a mortgage agent, and a property information;
request a second interface, wherein the second interface is tailored to receive loan information;
provide loan information to the source;
receive a third interface, wherein the third interface includes an estimated monthly cost; and
save at least the monthly cost and property information to a computer readable medium incorporated in the network access device.

2. A system for matching real estate professionals, the system comprising:
a microprocessor based match engine, wherein the match engine is communicably coupled to a first computer readable medium, a second computer readable medium, a third computer readable medium, and a fourth computer readable medium;
wherein the first computer readable medium comprises a group of real estate professionals of a first type;
wherein the second computer readable medium comprises a group of real estate professionals of a second type;
wherein the third computer readable medium comprises a relationship between one or more of the group of real estate professionals of the first type and at least one of the real estate professionals of the second type; and
wherein the fourth computer readable medium comprises instructions executable by the match engine to:
receive a code via a computer network, wherein the code is associated with a first real estate professional from the group of real estate professionals of the first type;
accessing the first computer readable medium, and obtaining a first data set associated with the first real estate professional;
accessing the third computer readable medium to obtain relationship information;
based at least in part on the relationship information, matching the first real estate professional with a second real estate professional from the group of real estate professionals of the second type;
accessing a second data set associated with the second real estate professional; and
provide an interface via the computer network, wherein the interface displays the first real estate professional and the second real estate professional.

3. The system of claim 2, wherein the first type of real estate professionals are mortgage agents, and wherein the second type of real estate professionals are real estate agents.

4. The system of claim 2, wherein the first type of real estate professionals are referring professionals, and the second type of real estate professionals are referred professionals.

5. The system of claim 2, wherein the first real estate professional is a mortgage agent, and wherein the second real estate professional is a real estate agent.

6. The system of claim 2, wherein the first real estate professional is a mortgage agent, and wherein the second real estate professional is a real estate agent, and wherein the instructions are further executable to:
access a loan origination tool specific to the mortgage agent; and
to receive a third data set associated with a purchaser.

7. The system of claim 6, wherein the third data set includes information selected from a group consisting of: a personal identification information, an income information, a credit information, a gross loan amount information, an escrow information, a down payment information, and a description of the real estate to be purchased.

8. The system of claim 6, wherein the computer instructions are further executable to:
provide a closing cost estimate interface to the purchaser, wherein the closing cost estimate interface includes at least a portion of the first data set and a portion of the second data set.

9. The system of claim 2, wherein the first real estate professional is a mortgage agent, and wherein the second real estate professional is a real estate agent, and wherein the instructions are further executable to:
access a seller net tool specific to the mortgage agent; and
to receive a third data set associated with a seller.

10. The system of claim 9, wherein the third data set includes information selected from a group consisting of: a personal identification information, an outstanding loan information, an escrow information, and a sales price.

11. The system of claim 9, wherein the computer instructions are further executable to:
provide a seller net interface to the seller, wherein the seller net includes at least a portion of the first data set, and a fourth data set including information associated with a real estate agent representing the seller.

12. The system of claim 2, wherein at least two of the first, second, third, and fourth computer readable mediums are implemented on the same hard disk drive.

13. A method for facilitating a real estate transaction, the method comprising:
associating a code with a real estate entity;
receiving the code via a communication network;
accessing a first data set associated with the real estate entity;
matching the real estate entity to an associated entity;
accessing a second data set associated with the associated entity;
providing an interface via the communication network, wherein the interface includes the first and second data sets.

14. The method of claim 13, wherein the real estate entity is a real estate agent.

15. The method of claim 14, wherein the associated entity is a mortgage agent.

16. The method of claim 13 wherein associated entity is a real estate agent, and wherein the real estate entity is a mortgage agent.

17. The method of claim 13, wherein the interface is a first interface, the method further comprising:
providing a second interface, wherein the second interface is tailored to accept information selected from a group consisting of: personal identification information, income information, credit information, employment information, authorizations to verify credit and employment information, location of a property to be purchased, cost of a property to be purchased, proposed down payment, home owners association dues, and property insurance, the multiple listing service number; and
providing a third interface, wherein the third interface provides an estimate of closing costs specific to one or both of the real estate entity and the associated entity.

18. The method of claim 13, wherein the code is provided from a transmitter associated with a property for sale.

19. The method of claim 13, wherein the interface is a first interface, the method further comprising:
providing a second interface, wherein the second interface is tailored to accept information selected from a group consisting of: personal identification information, location of a property to be sold, cost of a property to be sold, and outstanding liabilities on the property to be sold; and
providing a third interface, wherein the third interface provides a seller's net interface using information specific to one or both of the real estate entity and the associated entity.

20. A method for providing a seamless real estate transaction, the method comprising:
providing a code associated with a proposed transaction, wherein the code indicates a real estate agent;
receiving the code;
providing an informational interface, wherein the informational interface includes information about the real estate agent and one or more mortgage agents associated with the real estate agent;
requesting transaction information; and
based at least in part on the transaction information, providing an estimate of the transaction costs, wherein the estimate includes contact information for both the real estate agent and a selected mortgage agent.

21. The method of claim 20, wherein the code is provided via a transmitter associated with a real estate sign.

22. The method of claim 20, wherein the code is provided to a real estate agent, and wherein the real estate agent provides the code to a potential purchaser.

23. The method of claim 20, the method further comprises receiving a request for the code, wherein the request for the code indicates the real estate agent;

24. The method of claim 23, wherein the request for the code further indicates the property for sale.

25. The method of claim 23, wherein the request for the code further identifies the potential purchaser.

26. A method for providing a seamless real estate transaction, the method comprising:
providing a code associated with a proposed transaction, wherein the code indicates a mortgage agent;
receiving the code;
providing an informational interface, wherein the informational interface includes information about the mortgage agent and one or more real estate agents associated with the mortgage agent;
requesting transaction information; and
based at least in part on the transaction information, providing an estimate of the transaction costs, wherein the estimate includes information specific to both the mortgage agent and a selected real estate agent.
